(19) United States
(12) Patent Application Publication
(10) Pub. No.: US 2026/0103215 A1
(43) Pub. Date: Apr. 16, 2026

(54) DATA DEVICE, LEARNING DATA GENERATION DEVICE, DATA CONVERSION PROGRAM PRODUCT, LEARNING DATA GENERATION PROGRAM PRODUCT, AND CONTROL SYSTEM

(71) Applicants: DENSO CORPORATION, Kariya-city (JP); NAGOYA DENKI EDUCATIONAL FOUNDATION, Nagoya-shi (JP)

(72) Inventors: Ken KINJO, Kariya-city (JP); Akira ITO, Toyota (JP)

(21) Appl. No.: 19/350,291

(22) Filed: Oct. 6, 2025

(30) Foreign Application Priority Data
Oct. 16, 2024 (JP) 2024-180790

(51) Int. Cl. B60W 60/00; B60W 50/00; G05B 13/02

(52) U.S. Cl. CPC B60W 60/001; B60W 50/0098; G05B 13/0265; B60W 2510/20; B60W 2520/105; B60W 2710/18; B60W 2710/20; B60W 2720/106

(57) ABSTRACT

A data device includes a reference conversion unit and a reconversion unit. The reference conversion unit inputs a reference operation parameter output by a reference machine control model established by machine learning an operation on a reference machine device, converts the reference operation parameter into a behavior parameter that is independent of individual machine devices, and outputs the behavior parameter. The reconversion unit reconverts the behavior parameter into a control operation parameter, which is an operation parameter having a same type of the reference operation parameter, in accordance with a machine characteristic of the control target machine device.

### CROSS REFERENCE TO RELATED APPLICATION

The present application claims the benefit of priority from Japanese Patent Application No. 2024-180790 filed on Oct. 16, 2024. The entire disclosure of the above application is incorporated herein by reference.

### TECHNICAL FIELD

The present disclosure relates to a data device, a learning data generation device, a data conversion program product, a learning data generation program product, and a control system for controlling a machine device.

### BACKGROUND

A conceivable technique teaches a neural network system for autonomously driving an autonomous driving vehicle.

In recent years, data-driven machine control methods based on machine learning have been attracting attention as a means of achieving proper control of machine control devices in complex situations involving various factors. While traditional rule-based and model-based methods build algorithms based on prior knowledge and mathematical models, the machine learning builds algorithms based on data, hence the machine control methods are defined as data-driven methods. While data-driven planners do not require prior knowledge or mathematical models, the data-driven planners require a huge amount of training data to allow machine learning models to acquire functionality. The data-driven planners receive peripheral information of the machine device and state information of the machine device as input, and outputs the manipulation variable of the machine device.

### SUMMARY

According to an example, a data device may include: a reference conversion unit that: inputs at least one reference operation parameter that is an operation parameter output by a reference machine device control model, which is a machine learning model established by machine learning an operation on a reference machine device as a reference of a machine device; converts the at least one reference operation parameter into at least one behavior parameter that does not depend on individual machine device using a machine device model which is a physical model based on a machine characteristic of the reference machine device; and output converted at least one behavior parameter; and a reconversion unit that is configured to reconvert the at least one behavior parameter output by the reference conversion unit into at least one control operation parameter that is an operation parameter having a same type of the at least one reference operation parameter, according to a machine characteristic of a control target machine device, which is a control target of the machine device. The at least one control operation parameter reconverted by the reconversion unit is output to the control target machine device.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing a configuration of a vehicle control system;

FIG. 2 is a functional block diagram showing the functional configuration of a vehicle control device;

FIG. 3 is a block diagram showing the configuration of a compensator;

FIG. 4 is a graph showing a travel trajectory when a vehicle turns left at an intersection;

FIG. 5 is a graph showing the change over time in steering amount when a vehicle turns left at an intersection;

FIG. 6 is a graph showing the change in yaw rate over time when a vehicle turns left at an intersection;

FIG. 7 is a block diagram showing a configuration of a training data generation device;

FIG. 8 is a functional block diagram showing the functional configuration of a training data generation device;

FIG. 9 is a block diagram showing a configuration of a data device according to the present embodiments;

FIG. 10 is a block diagram showing a configuration of a training data generation device according to the present embodiments; and

FIGS. 11A and 11B are diagrams showing tables of definitions of the variables and parameters.

### DETAILED DESCRIPTION

As a result of detailed studies by the inventors, the following difficulties have been found. The model-based planner clearly separates the roles of recognition, determination, and operation, and both the parameters within the divisions and the parameters exchanged between the divisions are interpretable and clear. Thus, it is possible to easily modify the parameters in response to design changes. On the other hand, the data-driven planner does not have a clear division of roles between recognition, determination, and operation, and is configured by large-scale neural network models. Thus, it is difficult to interpret the parameters and variables within a data-driven planner. As a result, it is difficult to modify parameters in response to design changes. For this reason, in a data-driven planner, it is necessary to change the learning data and execute the learning again every time the specifications of the machine device are changed. Furthermore, when the learning data is applied to a machine device that is a different model from the machine device that acquired the learning data, there is a possibility that the required behavior may not be acquired due to the different characteristics of each machine device. In this case, it becomes necessary to start learning from scratch for each machine device.

The present embodiments provide an easy establishment of a machine learning model used to control a machine device.

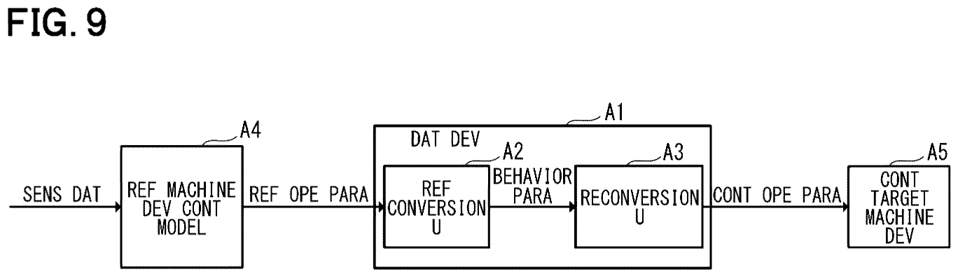

One aspect of the present embodiments is a data device that includes a reference conversion unit and a reconversion unit, as shown in FIG. 9, and outputs a control operation parameter reconverted by the reconversion unit to a control target machine device.

The reference conversion unit inputs at least one reference operation parameter that is an operation parameter output by a reference machine device control model, which is a machine learning model established by machine learning an operation on a reference machine device as a reference of the machine device. The reference conversion unit converts the reference operation parameter into at least one behavior parameter that does not depend on individual machine device using a reference machine device model which is a physical model based on a machine characteristic of the reference machine device. The reference conversion unit is configured to output converted at least one behavior parameter.

The reconversion unit is configured to reconvert the at least one behavior parameter output by the reference conversion unit into at least one control operation parameter that is an operation parameter having a same type of the at least one reference operation parameter, depending on the machine characteristic of the control target machine device, which is a control target of the machine device.

The data device of the present embodiments configured in this manner outputs, to the control target machine device, the control operation parameter generated by converting the reference operation parameter output by the reference machine device control model. As a result, in order to control the control target machine device, the control device according to the present embodiments does not need to newly establish by re-learning a machine device control model for outputting the operation parameter by machine learning an operation of the control target machine device. Therefore, in the data device according to the present embodiments, it is not necessary to establish a machine device control model for each of multiple control target machine devices having different models from each other, and it is possible to easily establish a machine device control model to be used to control the machine devices.

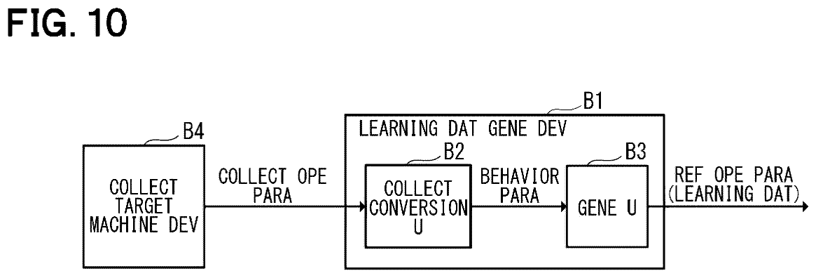

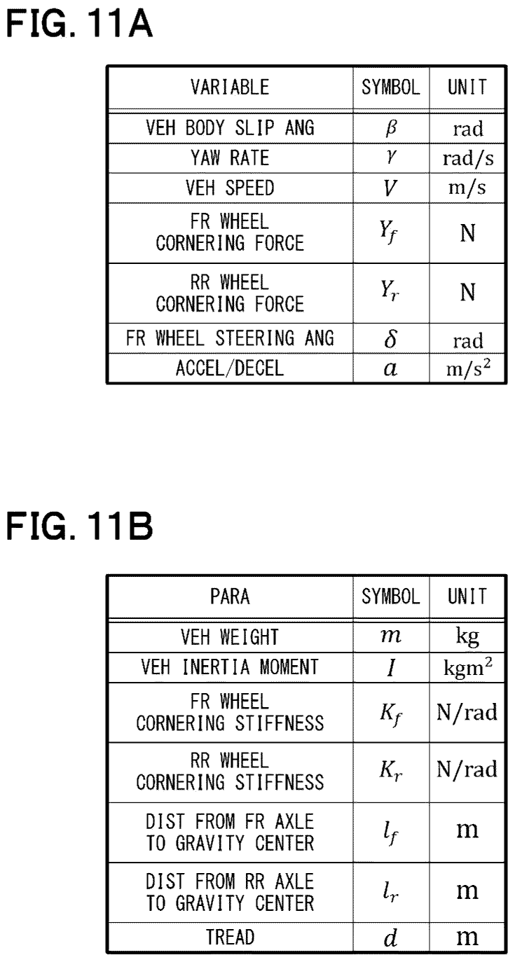

Another aspect of the present embodiments is a training data generation device that generates training data for machine learning, as shown in FIG. 10, and includes a collection conversion unit and a generation unit.

The collection conversion unit receives at least one collection operation parameter that is an operation parameter for operating a collection target machine device, which is a machine device for collecting data. The collection conversion unit converts the collection operation parameter into at least one behavior parameter that does not depend on individual machine device using a machine device model which is a physical model based on a machine characteristic of the collection target machine device. The collection conversion unit is configured to output converted at least one behavior parameter.

The generation unit is configured to generate learning data by reconverting at least one operational parameter output by the collection conversion unit into at least one reference operational parameter that is an operational parameter having a same type of the at least one collection operation parameter, depending on the machine characteristic of a reference machine device that is a reference of the machine device.

The learning data generation device of the present embodiments configured in this manner can generate learning data for a reference machine device control model established by machine learning an operation on a reference machine device using multiple collection target machines having different models from each other, and therefor, it is possible to easily establish a machine device control model to be used to control a machine device.

Yet another aspect of the present embodiments is a data conversion program for causing a computer to function as a reference conversion unit and a reconversion unit, and outputting a control operation parameter reconverted by the reconversion unit to a control target machine device.

A computer controlled by the data conversion program of the present embodiments can constitute a part of the data device of the present embodiments, and can acquire the same effects as the data device of the present embodiments.

Yet another aspect of the present embodiments is a training data generation program for causing a computer of a training data generation device that generates training data for machine learning to function as a collection conversion unit and a generation unit.

A computer controlled by the training data generation program of the present embodiments can constitute a part of the training data generation device of the present embodiments, and can acquire the same effects as the training data generation device of the present embodiments.

Yet another aspect of the present embodiments is a control system having a reference conversion unit and a reconversion unit, and controlling a control target machine device based on a control operation parameter reconverted by the reconversion unit.

The control system of the present embodiments is a system that includes the data device of the present embodiments, and can acquire the same effects as the data device of the present embodiments.

### First Embodiment

Hereinafter, a first embodiment according to the present disclosure will be described with reference to the drawings.

The vehicle control system 1 of this embodiment is mounted on a vehicle capable of autonomous driving. The autonomous driving is the automatic operation of driving a vehicle on behalf of the vehicle occupants. The vehicle control system 1 enables, for example, autonomous driving of level 3 or higher. The automation level of autonomous driving may refer to the automation level defined by the Society of Automotive Engineers (SAE) of America.

A vehicle equipped with the vehicle control system 1 may have a manual driving function in addition to an autonomous driving function. The vehicle may be a hybrid vehicle with an engine and an electric motor as the drive source for travel. The vehicle is not limited to a vehicle with an autonomous driving function or a hybrid vehicle, but may be a vehicle having only an engine or only an electric motor as a driving source for travel. Hereinafter, the vehicle in which the vehicle control system 1 is mounted is simply referred to as the control vehicle.

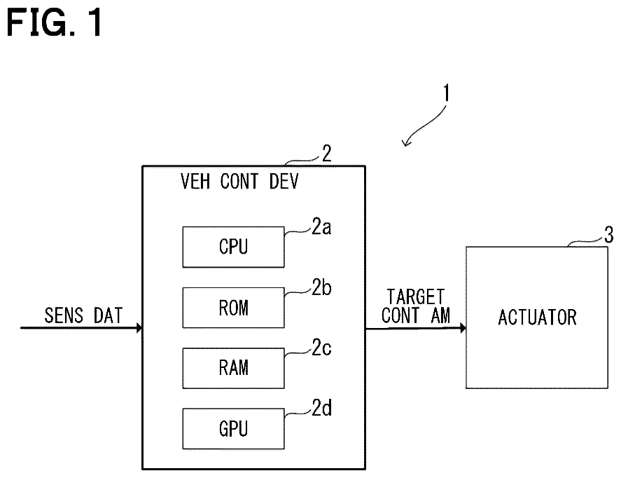

As shown in FIG. 1, the vehicle control system 1 includes a vehicle control device 2 and an actuator 3.

The vehicle control device 2 is an electronic control device mainly configured with a microcomputer including a CPU 2a, a ROM 2b, a RAM 2c, a GPU 2d, and the like. Various functions of the microcomputer are implemented by the CPU 2a executing a program stored in a non-transitory tangible storage medium. For example, the ROM 2b corresponds to the non-transitory tangible storage medium storing the program. A method corresponding to the program is performed by executing the program. Some or all of the functions executed by the CPU 2a may be configured as hardware by one or a plurality of ICs or the like. Alternatively, the number of the microcomputers constituting the vehicle control device 2 may be one or more.

The vehicle control device 2 receives sensor data generated by one or more sensors (not shown) that detect the conditions around the control vehicle and the conditions of the control vehicle, and outputs a target control amount. Examples of sensor data include camera images from an in-vehicle camera and the amount of vehicle operation. It may also be sensor information, such as Lidar or radar, for grasping the surrounding environment of the control vehicle and the state of the control vehicle. In the following, acceleration/deceleration a(t) and front wheel steering angle ^{˜}δ(t) are given as examples of control amounts, but acceleration, an accelerator opening degree, a brake operation degree, brake fluid pressure, a steering wheel angle, and the like may also be used.

The actuator 3 operates the accelerator, the brake device and the steering device of the control vehicle based on the acceleration and deceleration a(t) and the front wheel steering angle ^{˜}δ(t).

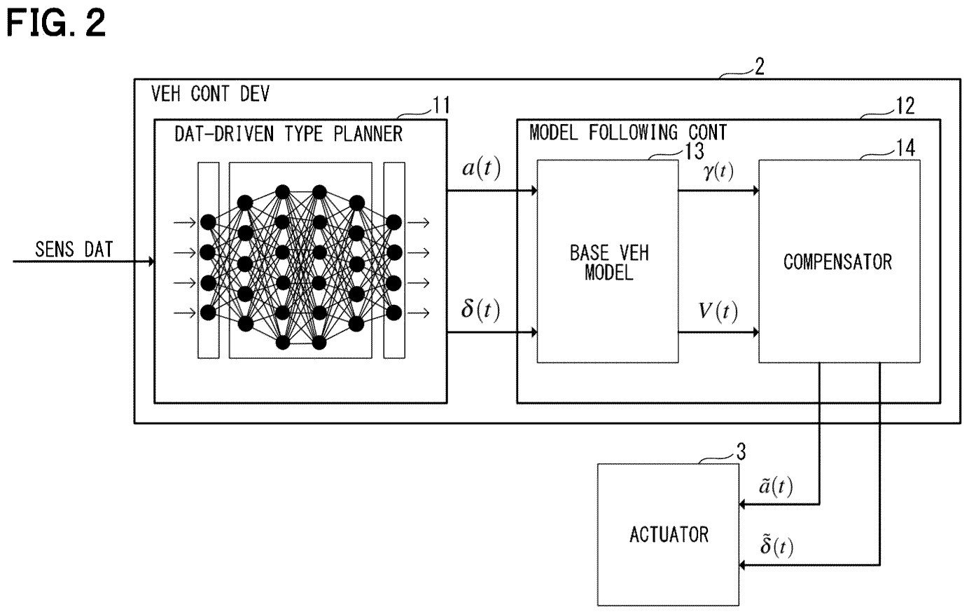

As shown in FIG. 2, the vehicle control device 2 includes a data-driven planner 11 and a model-following controller 12 as functional blocks realized by a CPU 2a executing a program stored in a ROM 2b.

The data-driven planner 11 has a learning model generated by performing machine learning using multiple vehicle surrounding image data around the base vehicle and multiple vehicle operation data (e.g., steering operation data, accelerator operation data, brake operation data) for operating the base vehicle. The base vehicle is a vehicle that collects the above vehicle surrounding image data and vehicle operation data for learning by the data-driven planner 11.

This learning model is a model that receives the image data captured by an in-vehicle camera as input data and outputs vehicle operation data, for example. The model following controller 12 includes a base vehicle model 13 and a compensator 14.

The method for realizing these elements that constitutes the vehicle control device 2 is not limited to software, and some or all of the elements may be realized using one or more pieces of hardware. For example, when the above functions are implemented by an electronic circuit that is hardware, the electronic circuit may be implemented by a digital circuit that includes a large number of logic circuits, an analog circuit, or a combination of the digital circuit and the analog circuit.

The base vehicle model 13 is a model that receives the acceleration and deceleration a(t) and the front wheel steering angle δ(t) as input data and outputs the vehicle speed V(t) and the yaw rate γ(t) as output data, and is established as a vehicle model having the same specifications as the vehicle from which the learning data was acquired (i.e., the base vehicle). The vehicle model of this embodiment is described by a vehicle mathematical model such as a dynamic two-wheel model shown in expressions (1) to (4).

$$\begin{matrix}( Expression 1 ) & \\ mV ( t ) \{ \dot{β} ( t ) + γ ( t ) \} = 2 {Y}_{f} ( t ) + 2 {Y}_{r} ( t ) & ( 1 )\end{matrix}$$

$$\begin{matrix}( Expression 2 ) & \\ I \dot{γ} ( t ) = 2 {Y}_{f} ( t ) {l}_{f} - 2 {Y}_{r} ( t ) {l}_{r} & ( 2 )\end{matrix}$$

$$\begin{matrix}( Expression 3 ) & \\ {Y}_{f} ( t ) = - {K}_{f} \{ β ( t ) + \frac{{l}_{f}}{V ( t )} γ ( t ) - δ ( t ) \} & ( 3 )\end{matrix}$$

$$\begin{matrix}( Expression 4 ) & \\ {Y}_{r} ( t ) = - {K}_{r} \{ β ( t ) - \frac{{l}_{r}}{V ( t )} γ ( t ) \} & ( 4 )\end{matrix}$$

The definitions of the variables and parameters in expression (1) to (4) are shown in FIGS. Table 11A and 11B.

Here, the vehicle speed V(t) is updated by expression (5) and is used not only as an output of the base vehicle model 13 but also in expressions (1) to (4).

$$\begin{matrix}( Expression 5 ) & \\ V ( t ) = {\int }_{0}^{t} a ( τ ) d τ & ( 5 )\end{matrix}$$

The base vehicle model 13 can be considered such that the output of the data-driven planner 11 is interpreted using a vehicle model with a clear internal structure. In this embodiment, the output of the planner, which is presented as the physical quantity of the actuator operation, is interpreted as the physical quantities of the vehicle behavior, namely, the vehicle speed and the yaw rate.

The compensator 14 is a target value tracking control system that sets the vehicle speed V(t) and the yaw rate γ(t), which are outputs of the base vehicle model 13, as target values and determines the acceleration and deceleration ^{˜}a(t) and the front wheel steering angle ^{˜}δ(t) so that the vehicle to which the data-driven planner 11 is actually applied tracks the target values. Since the relationship between the acceleration and deceleration and the vehicle speed does not depend on the vehicle specifications, the acceleration and deceleration ^{˜}a(t) is the same value as the output of the data-driven planner 11 (i.e., acceleration and deceleration a(t)). Therefore, the calculation of the front wheel steering angle ^{˜}δ(t) will be explained below.

The target value tracking control system is implemented by a control system based on a vehicle mathematical model, similar to the base vehicle model 13. For example, this is realized by adaptive control based on a dynamic two-wheel model. The compensator 14 uses the nonlinear system shown in expressions (6) and (7).

$$\begin{matrix}( Expression 6 ) & \\ \dot{x} ( t ) = G ( x ) + H ( x ) u ( t ) & ( 6 )\end{matrix}$$

$$\begin{matrix}( Expression 7 ) & \\ y ( t ) = C x ( t ) & ( 7 )\end{matrix}$$

Here, the expressions of “x(t)∈Rⁿ”, “u(t)∈R^{m}”, “y(t)∈R^{l}”, “G(x)∈Rⁿ”, “H(x)∈R^{n×m}”, and “C∈R^{l×n}” are satisfied, and G(x) and H(x) are smooth nonlinear functions of x(t).

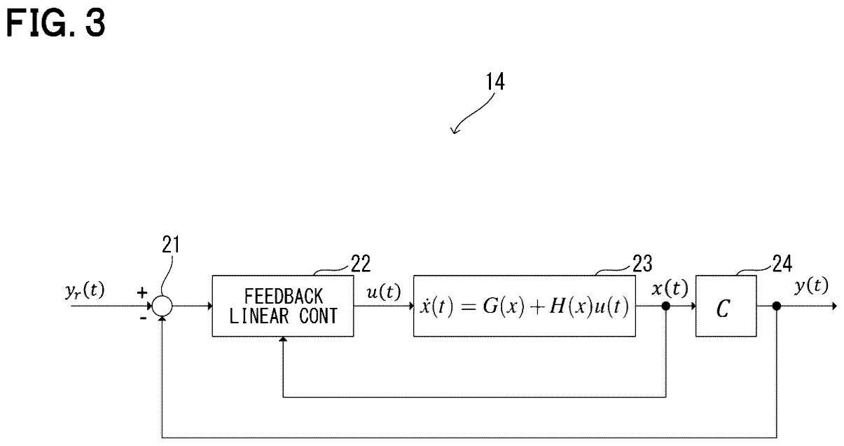

As shown in FIG. 3, the compensator 14 includes a subtractor 21, a feedback linearization controller 22, a calculation unit 23, and a multiplier 24. The subtractor 21 subtracts y(t) output from the multiplier 24 from yᵣ(t), which is the target value of y(t), and outputs the subtraction result.

The feedback linearization controller 22 calculates u(t) from v(t) output by the subtractor 21 and outputs u(t). The calculation unit 23 calculates x(t) from expression (6) based on u(t) output by the feedback linearization controller 22, and outputs x(t).

The multiplier 24 multiplies the x(t) output from the calculation unit 23 by a preset constant C, and outputs the multiplication result as y(t). In this embodiment, the longitudinal motion of the vehicle is described by a mass point model, and the lateral motion and rotational motion around the center of gravity are described by a dynamic two-wheel model. Here, x(t), u(t), y(t), G(x), H(x), and C in expressions (6) and (7) are defined as shown in expressions (8), (9), (10), (11), (12), and (13), respectively. Here, F(t) represents the total braking and driving force. Furthermore, the vehicle parameters of each model use the specifications of the vehicle to which the planner is applied (i.e., the control vehicle).

$$\begin{matrix}( Expression 8 ) & \\ x ( t ) = {[ β ( t ) γ ( t ) V ( t ) ]}^{T} & ( 8 )\end{matrix}$$

$$\begin{matrix}( Expression 9 ) & \\ u ( t ) = {[ \tilde{δ} ( t ) F ( t ) ]}^{T} & ( 9 )\end{matrix}$$

$$\begin{matrix}( Expression 10 ) & \\ y ( t ) = {[ γ ( t ) V ( t ) ]}^{T} & ( 10 )\end{matrix}$$

$$\begin{matrix}( Expression 11 ) & \\ G ( x ) = [ \begin{matrix}- \frac{2 ( {K}_{f} + {K}_{r} )}{mV ( t )} β ( t ) - \{ 1 + \frac{2 ( {l}_{f} {K}_{f} - {l}_{r} {K}_{r} )}{{mV}^{2} ( t )} \} γ ( t ) \\ - \frac{2 ( {l}_{f} {K}_{f} - {l}_{r} {K}_{r} )}{I} β ( t ) - \frac{2 ( {l}_{f}^{2} {K}_{f} + {l}_{r}^{2} {K}_{r} )}{IV ( t )} γ ( t ) \\ 0\end{matrix} ] & ( 11 )\end{matrix}$$

$$\begin{matrix}( Expression 12 ) & \\ H ( x ) = [ \begin{matrix}\frac{2 {K}_{f}}{mV ( t )} & 0 \\ \frac{2 {l}_{f} {K}_{f}}{I} & 0 \\ 0 & \frac{1}{m}\end{matrix} ] & ( 12 )\end{matrix}$$

$$\begin{matrix}( Expression 13 ) & \\ C = [ \begin{matrix}0 & 1 & 0 \\ 0 & 0 & 1\end{matrix} ] & ( 13 )\end{matrix}$$

The acceleration and deceleration a(t) is calculated by expressions (14).

$$\begin{matrix}( Expression 14 ) & \\ \tilde{a} ( t ) = \frac{F ( t )}{m} & ( 14 )\end{matrix}$$

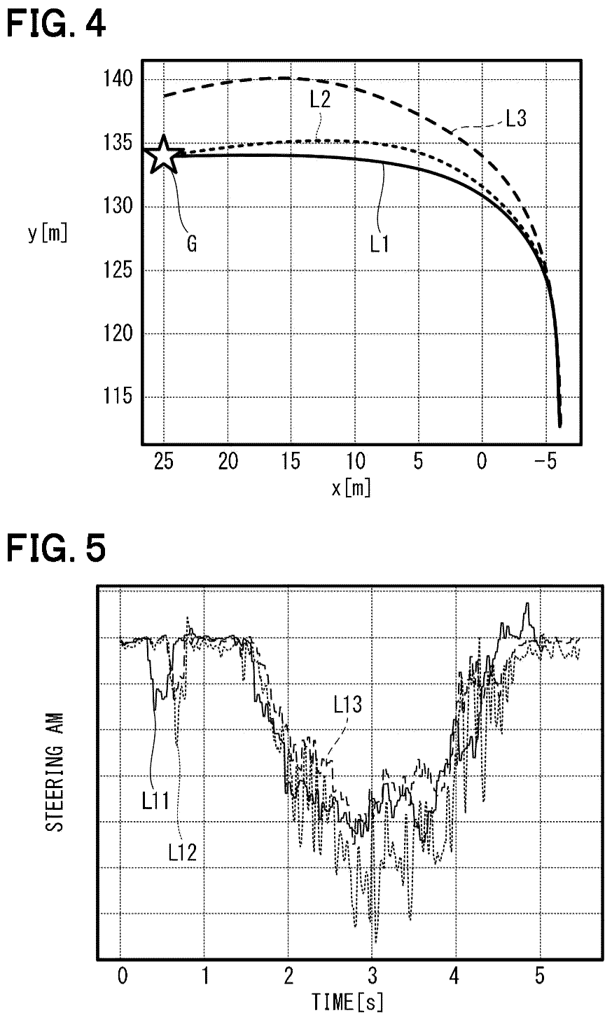

FIG. 4 shows the results of a vehicle simulation showing the travel trajectories of the base vehicle and the control vehicle when turning left at an intersection. A curve L1 in FIG. 4 indicates the travel trajectory of the base vehicle. The curve L2 indicates the travel trajectory of the control vehicle when the vehicle control device 2 is equipped with the data-driven planner 11 and the model-following controller 12. The curve L3 indicates the travel trajectory of the control vehicle when the vehicle control device 2 is equipped with the data-driven planner 11 but not with the model-following controller 12.

As shown in FIG. 4, when only the data-driven planner 11 is applied to a control vehicle that is different from the base vehicle, the travel trajectory of the control vehicle deviates significantly from the travel trajectory of the base vehicle.

On the other hand, when the data-driven planner 11 and the model-following controller 12 are applied to the control vehicle, the target position G of the control vehicle coincides with the travel trajectory of the base vehicle, and the trajectory of the control vehicle becomes similar to the travel trajectory of the base vehicle.

FIG. 5 shows the results of a vehicle simulation showing the change over time in the steering amount when the base vehicle and the control vehicle turn left at an intersection.

A line L11 in FIG. 5 shows the change in the steering amount of the base vehicle over time. The line L12 indicates the change over time in the steering amount of the control vehicle when the vehicle control device 2 is equipped with the data-driven planner 11 and the model-following controller 12. The line L13 indicates the change over time in the steering amount of the control vehicle when the vehicle control device 2 is equipped with the data-driven planner 11 but is not equipped with the model-following controller 12.

As shown in FIG. 5, when the data-driven planner 11 and the model-following controller 12 are applied to the control vehicle, the steering amount of the control vehicle is corrected with respect to the steering amount of the base vehicle.

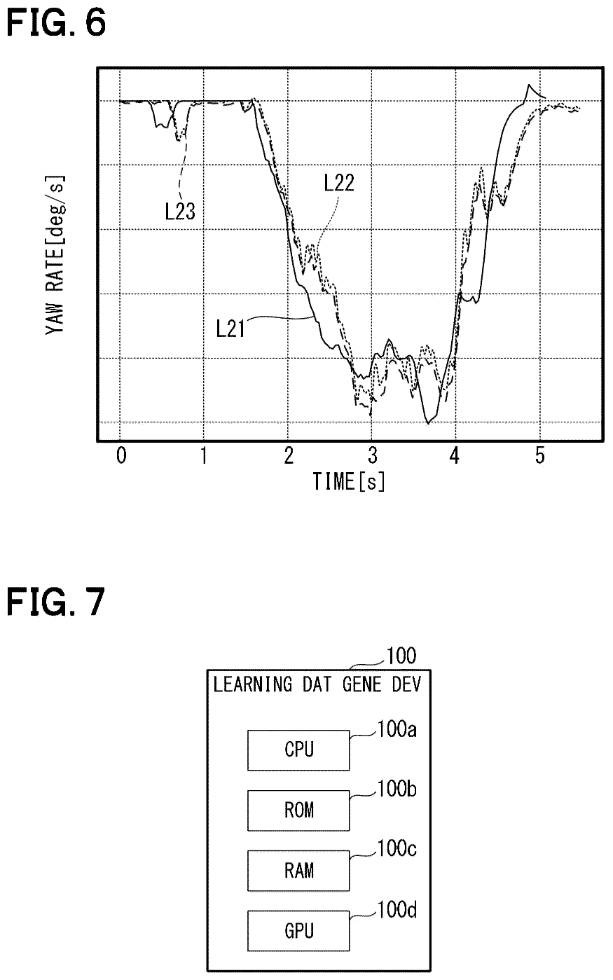

FIG. 6 shows the results of a vehicle simulation showing the change in yaw rate over time when the base vehicle and the control vehicle turn left at an intersection.

The line L21 in FIG. 6 indicates the change in yaw rate of the base vehicle over time. The line L22 shows the change over time in the yaw rate of the control vehicle when the vehicle control device 2 is equipped with the data-driven planner 11 and the model-following controller 12. The line L23 indicates the target yaw rate output by the data-driven planner 11.

As shown in FIG. 6, the steering amount is corrected by the model following control, so that the yaw rate of the control vehicle substantially coincides with the target yaw rate. The vehicle control device 2 configured in this manner includes a base vehicle model 13 and a compensator 14.

The base vehicle model 13 is configured to input the acceleration and deceleration a(t) and the front wheel steering angle δ(t) output by the data-driven planner 11, which is a machine learning model established by the machine learning of the operation on the base vehicle, convert them into a vehicle speed V(t) and a yaw rate γ(t) that are independent of individual vehicles using a dynamic two-wheel model, which is a physical model based on the mechanical characteristic of the base vehicle, and output the converted vehicle speed V(t) and yaw rate γ(t).

The compensator 14 is configured to reconvert the vehicle speed V(t) and the yaw rate γ(t) output by the base vehicle model 13 into the acceleration and deceleration ^{˜}a(t) and the front wheel steering angle ^{˜}δ(t), which are operation parameters similar to the acceleration and deceleration a(t) and the front wheel steering angle δ(t), in accordance with the mechanical characteristic of the control vehicle.

The vehicle control device 2 outputs the reconverted acceleration and deceleration ^{˜}a(t) and the reconverted front wheel steering angle ^{˜}δ(t) to the control vehicle. That is, the vehicle control device 2 controls the control vehicle based on the reconverted acceleration and deceleration a(t) and the front wheel steering angle ^{˜}δ(t).

The base vehicle model 13 is established as a vehicle model having the same specifications as the base vehicle, with the acceleration and deceleration a(t) and the front wheel steering angle δ(t) as inputs and the vehicle speed V(t) and the yaw rate γ(t) as outputs.

The compensator 14 performs the target value tracking control, which uses the movement indicated by the yaw rate γ(t) as a target value and determines the front wheel steering angle δ(t) so that the control vehicle moves with tracking the target value.

Such a vehicle control device 2 converts the acceleration and deceleration a(t) and the front wheel steering angle δ(t) output by the data-driven planner 11, and outputs the acceleration and deceleration ^{˜}a(t) and the front wheel steering angle ^{˜}δ(t) generated by the conversion to the control vehicle. As a result, in order to control the control vehicle, the vehicle control device 2 does not need to newly reestablish a data-driven planner 11 through relearning, which outputs the acceleration and deceleration ^{˜}a(t) and the front wheel steering angle ^{˜}δ(t) by the machine learning of the operation on the control vehicle. Therefore, in the vehicle control device 2, it is not necessary to establish a data-driven planner 11 for each of multiple control vehicles having different vehicle types, so that it is possible to easily establish the data-driven planner 11 used to control the control vehicles.

In the embodiment described above, the vehicle control device 2 corresponds to a data device and a control system, the base vehicle model 13 corresponds to a reference conversion unit, the compensator 14 corresponds to a reconversion unit, and the data-driven planner 11 corresponds to a reference machine device control model.

Furthermore, the base vehicle corresponds to the reference machine device, the acceleration and deceleration a(t) and the front wheel steering angle δ(t) correspond to the reference operation parameters, the dynamic two-wheel model corresponds to the machine device model, and the vehicle speed V(t) and the yaw rate γ(t) correspond to the behavior parameters.

The control vehicle corresponds to the control target machine device, and the acceleration and deceleration ˜a(t) and the front wheel steering angle ˜δ(t) correspond to the control operation parameters.

### Second Embodiment

Hereinafter, a second embodiment according to the present disclosure will be described with reference to the drawings.

The training data generation device 100 of this embodiment is a device that generates training data for performing the machine learning for the data-driven planner 11, and is mainly configured by a microcomputer equipped with a CPU 100a, a ROM 100b, a RAM 100c, a GPU 100d, and the like, as shown in FIG. 7.

Various functions of the microcomputer are implemented by the CPU 100a executing a program stored in a non-transitory tangible storage medium. For example, the ROM 100b corresponds to the non-transitory tangible storage medium storing the program. A method corresponding to the program is performed by executing the program. Some or all of the functions executed by the CPU 100a may be configured as hardware by one or a plurality of ICs or the like. Furthermore, the number of microcomputers constituting the training data generation device 100 may be one or more.

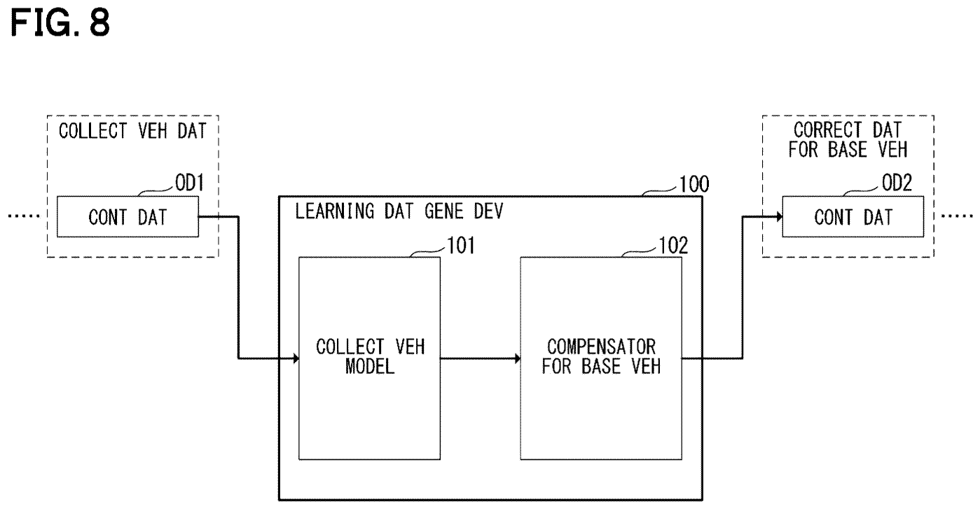

As shown in FIG. 8, a plurality of control data OD1 (for example, steering operation data, accelerator operation data, and brake operation data) for controlling the data collection vehicle is acquired when the data collection vehicle travels.

The training data generating device 100 includes a collection vehicle model 101 and a base vehicle compensator 102 as functional blocks realized by the CPU 100a executing a program stored in the ROM 100b.

The collection vehicle model 101, similar to the base vehicle model 13, is a dynamic two-wheel model that receives the acceleration and deceleration and the front wheel steering angle as input data and outputs the vehicle speed and the yaw rate as output data, and is established as a vehicle model with the same specifications as the vehicle from which the learning data was acquired (i.e., the data collection vehicle). The acceleration and deceleration and the front wheel steering angle input to the collection vehicle model 101 are calculated using the control data OD1.

The compensator 102 for the base vehicle has a configuration similar to that of the compensator 14, and is a target value tracking control system that uses the vehicle speed V and the yaw rate γ, which are the outputs of the collection vehicle model 101, as target values and determines the acceleration and deceleration and the front wheel steering angle so that the base vehicle tracks the target values.

That is, the base vehicle compensator 102 uses the nonlinear system shown in expressions (6) and (7). In this embodiment, the longitudinal motion of the vehicle is described by a mass point model, and the lateral motion and rotational motion around the center of gravity are described by a dynamic two-wheel model. Here, x(t), u(t), y(t), G(x), H(x), and C in expressions (6) and (7) are defined as shown in expressions (8), (9), (10), (11), (12), and (13), respectively. Here, the vehicle parameters of each model use the specifications of the base vehicle.

The base vehicle compensator 102 outputs a plurality of control data OD2 based on the acceleration and deceleration and the front wheel steering angle input from the collection vehicle model 101.

The training data generation device 100 configured in this manner includes a collection vehicle model 101 and a compensator 102 for a base vehicle.

The collection vehicle model 101 is configured to input multiple control data OD1 for operating a data collection vehicle to collect data, convert the data into the vehicle speed and the yaw rate that are independent of individual vehicles using a dynamic two-wheel model based on the mechanical characteristic of the data collection vehicle, and output the converted vehicle speed and the converted yaw rate.

The compensator 102 for the base vehicle is configured to generate the learning data by reconverting the vehicle speed and the yaw rate output by the collection vehicle model 101 into a plurality of control data OD2, which are operation data having the same type as the plurality of control data OD1, according to the mechanical characteristic of the base vehicle.

Such a learning data generation device 100 can generate the learning data for a data-driven planner 11, which is established by the machine learning of the operation on a base vehicle, using multiple data collection vehicles having different models from each other, so that it is possible to easily establish a data-driven planner 11 used to control a vehicle.

In the embodiment described above, the collection vehicle model 101 corresponds to the collection conversion unit, the base vehicle compensator 102 corresponds to the generation unit, the data collection vehicle corresponds to the collection target machine device, the control data OD1 corresponds to the collection operation parameters, and the control data OD2 corresponds to the reference operation parameters.

Although one embodiment of the present disclosure has been described above, the present disclosure is not limited to the above embodiment, and various modifications can be made.

### First Modification

In the above embodiment, the machine device as the control target is a vehicle, but it is not limited to a vehicle and may be, for example, a robot, an aircraft, an artificial satellite, a ship, or the like.

### Second Modification

In the above embodiment, the base vehicle model 13 and the compensator 14 are mounted on the control vehicle. Alternatively, the base vehicle model 13 and the compensator 14 may be mounted on a device installed outside the control vehicle (for example, a server capable of data communication with the vehicle).

The vehicle control device 2 and the technique of the vehicle control device 2 according to the present disclosure may be achieved by a dedicated computer provided by constituting a processor and a memory programmed to execute one or more functions embodied by a computer program. Alternatively, the vehicle control device 2 and the technique according to the present disclosure may be achieved by a dedicated computer provided by constituting a processor with one or more dedicated hardware logic circuits. Alternatively, the vehicle control device 2 and the technique of the display device according to the present disclosure may be achieved using one or more dedicated computers constituted by a combination of a processor and a memory programmed to execute one or more functions and a processor formed of one or more hardware logic circuits. The computer program may be stored in a computer-readable non-transitory tangible storage medium as instructions to be executed by the computer. The technique for realizing the functions of the respective units included in the vehicle control device 2 does not necessarily need to include software, and all of the functions may be realized with the use of one or multiple hardware.

Multiple functions belonging to one configuration element in the above-described embodiment may be implemented by multiple configuration elements, or one function belonging to one configuration element may be implemented by multiple configuration elements. Multiple functions of multiple elements may be implemented by one element, or one function implemented by multiple elements may be implemented by one element. Part of the configuration of the above embodiment may be omitted. At least a part of the configuration of the described above embodiment may be added to or replaced with another configuration of the described above embodiment.

The present disclosure can be realized in various forms, in addition to the vehicle control device 2 described above, such as a system including the vehicle control device 2 as a component, a program for causing a computer to function as the vehicle control device 2, a non-transitory tangible storage medium such as a semiconductor memory storing the program, or a control method of a vehicle control device 2.

In addition to the above-described training data generation device 100, the present disclosure can also be realized in various forms, such as a system including the training data generation device 100 as a component, a program for causing a computer to function as the training data generation device 100, a non-transitory tangible storage medium such as a semiconductor memory on which the program is stored, and a training data generation method.

Reference numeral 2 indicates a vehicle control device, reference numeral 11 indicates a data-driven planner, reference numeral 13 indicates a base vehicle model, reference numeral 14 indicates a compensator, reference numeral 100 indicates a learning data generation device, reference numeral 101 indicates a collection vehicle model, and reference numeral 102 indicates a compensator.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A data device comprising:
at least one processor with a memory, wherein:
the at least one processor with the memory is configured to cause the data device to execute:
inputting at least one reference operation parameter that is an operation parameter output by a reference machine device control model, which is a machine learning model established by machine learning an operation on a reference machine device as a reference of a machine device;
converting the at least one reference operation parameter into at least one behavior parameter that does not depend on individual machine device using a machine device model which is a physical model based on a machine characteristic of the reference machine device;
outputting converted at least one behavior parameter; and
reconverting the at least one behavior parameter, output in the outputting of the converted at least one behavior parameter, into at least one control operation parameter that is an operation parameter having a same type of the at least one reference operation parameter, according to a machine characteristic of a control target machine device, which is a control target of the machine device; and
the at least one control operation parameter reconverted in the reconverting of the at least one behavior parameter is output to the control target machine device.

2. The data device according to claim 1, wherein:
the at least one processor with the memory is further configured to cause the data device to execute: receiving the at least one reference operation parameter as an input, outputs the at least one behavior parameter as an output, and is established using the machine device model having a same specification of the reference machine device.

3. The data device according to claim 1, wherein:
the at least one processor with the memory is further configured to cause the data device to execute: performing target value tracking control, in which a behavior indicated by the at least one behavior parameter is set as a target value, and the control operation parameter is determined so that the control target machine device performs the behavior that tracks the target value.

4. The data device according to claim 1, wherein:
the at least one processor with the memory is configured to cause the data device to execute:
inputting at least one reference operation parameter that is an operation parameter output by a reference machine device control model, which is a machine learning model established by machine learning an operation on a reference machine device as a reference of a machine device;
converting the at least one reference operation parameter into at least one behavior parameter that does not depend on individual machine device using a machine device model which is a physical model based on a machine characteristic of the reference machine device; and
outputting converted at least one behavior parameter, as a reference conversion unit; and
the at least one processor with the memory is configured to cause the data device to execute:
reconverting the at least one behavior parameter, output in the outputting of the converted at least one behavior parameter, into at least one control operation parameter that is an operation parameter having a same type of the at least one reference operation parameter, according to a machine characteristic of a control target machine device, which is a control target of the machine device, as a reconversion unit.

5. The data device according to claim 1, wherein:
the at least one control operation parameter reconverted in the reconverting of the at least one behavior parameter is output to the control target machine device to autonomously drive the control target machine device.

6. The data device according to claim 5, wherein:
the at least one control operation parameter reconverted in the reconverting of the at least one behavior parameter includes an acceleration and deceleration amount and a front wheel steering angle; and
the control target machine device is controlled to execute autonomous driving based on the acceleration and deceleration amount and the front wheel steering angle using an accelerator, a brake device and a steering device of the control target machine vehicle.

7. A learning data generation device that generates learning data for machine learning, comprising:
at least one processor with a memory, wherein:
the at least one processor with the memory is configured to cause the learning data generation device to execute:
receiving at least one collection operation parameter that is an operation parameter for operating a collection target machine device, which is a machine device for collecting data;
converting the collection operation parameter into at least one behavior parameter that does not depend on individual machine device using a machine device model which is a physical model based on a machine characteristic of the collection target machine device;
outputting converted at least one behavior parameter; and
generating learning data by reconverting at least one behavior parameter, output in the outputting of the converted at least one behavior parameter, into at least one reference operation parameter that is an operation parameter having a same type of the at least one collection operation parameter, according to a machine characteristic of a reference machine device that is a reference of the machine device.

8. The learning data generation device according to claim 7, wherein:
the at least one processor with the memory is configured to cause the data device to execute:
receiving at least one collection operation parameter that is an operation parameter for operating a collection target machine device, which is a machine device for collecting data;
converting the collection operation parameter into at least one behavior parameter that does not depend on individual machine device using a machine device model which is a physical model based on a machine characteristic of the collection target machine device; and
outputting converted at least one behavior parameter, as a collection conversion unit; and
the at least one processor with the memory is configured to cause the data device to execute:
generating learning data by reconverting at least one behavior parameter, output in the outputting of the converted at least one behavior parameter, into at least one reference operation parameter that is an operation parameter having a same type of the at least one collection operation parameter, according to a machine characteristic of a reference machine device that is a reference of the machine device, as a generation unit.

9. The learning data generation device according to claim 7, wherein:
the at least one collection operation parameter is output to the collection target machine device to autonomously drive the collection target machine device.

10. The learning data generation device according to claim 9, wherein:
the at least one collection operation parameter includes an acceleration and deceleration amount and a front wheel steering angle; and
the collection target machine device is controlled to execute autonomous driving based on the acceleration and deceleration amount and the front wheel steering angle using an accelerator, a brake device and a steering device of the collection target machine device.

11. A data conversion program product comprising: instructions, wherein:
the instructions cause a computer to function as:
a reference conversion unit that: inputs at least one reference operation parameter that is an operation parameter output by a reference machine device control model, which is a machine learning model established by machine learning an operation on a reference machine device as a reference of the machine device; converts the at least one reference operation parameter into at least one behavior parameter that does not depend on individual machine device using a machine device model which is a physical model based on a machine characteristic of the reference machine device; and output converted at least one behavior parameter; and
a reconversion unit that is configured to reconvert the at least one behavior parameter output by the reference conversion unit into at least one control operation parameter that is an operation parameter having a same type of the at least one reference operation parameter, according to a machine characteristic of a control target machine device, which is a control target of the machine device, wherein:
the at least one control operation parameter reconverted by the reconversion unit is output to the control target machine device.

12. The data conversion program product according to claim 11, wherein:
the at least one control operation parameter reconverted by the reconversion unit is output to the control target machine device to autonomously drive the control target machine device.

13. The data conversion program product according to claim 12, wherein:
the at least one control operation parameter reconverted by the reconversion unit includes an acceleration and deceleration amount and a front wheel steering angle; and
the control target machine device is controlled to execute autonomous driving based on the acceleration and deceleration amount and the front wheel steering angle using an accelerator, a brake device and a steering device of the control target machine vehicle.

14. A learning data generation program product comprising: instructions, wherein:
the instructions cause a computer of a learning data generation device, which generates learning data for machine learning, to function as:
a collection conversion unit that: receives at least one collection operation parameter that is an operation parameter for operating a collection target machine device, which is a machine device for collecting data; converts the at least one collection operation parameter into at least one behavior parameter that does not depend on individual machine device using a machine device model which is a physical model based on a machine characteristic of the collection target machine device; and outputs converted at least one behavior parameter; and
a generation unit that is configured to generate learning data by reconverting the at least one behavior parameter output by the collection conversion unit into at least one reference operation parameter that is an operation parameter having a same type of the at least one collection operation parameter, according to a machine characteristic of a reference machine device that is a reference of the machine device.

15. The learning data generation program product according to claim 14, wherein:
the at least one collection operation parameter is output to the collection target machine device to autonomously drive the collection target machine device.

16. The learning data generation device according to claim 15, wherein:
the at least one collection operation parameter includes an acceleration and deceleration amount and a front wheel steering angle; and
the collection target machine device is controlled to execute autonomous driving based on the acceleration and deceleration amount and the front wheel steering angle using an accelerator, a brake device and a steering device of the collection target machine device.

17. A control system comprising:
at least one processor with a memory, wherein:
the at least one processor with the memory is configured to cause the control system to execute:
inputting at least one reference operation parameter that is an operation parameter output by a reference machine device control model, which is a machine learning model established by machine learning an operation on a reference machine device as a reference of the machine device;
converting the at least one reference operation parameter into at least one behavior parameter that does not depend on individual machine device using a machine device model which is a physical model based on a machine characteristic of the reference machine device;
outputting converted at least one behavior parameter;
reconverting the at least one behavior parameter, output in the outputting of the converted at least one behavior parameter, into at least one control operation parameter that is an operation parameter having a same type of the at least one reference operation parameter, according to a machine characteristic of a control target machine device, which is a control target of the machine device, wherein:
the at least one control operation parameter reconverted in the reconverting of the at least one behavior parameter is output to the control target machine device.

18. The control system according to claim 17, wherein:
the at least one processor with the memory is configured to cause the data device to execute:
inputting at least one reference operation parameter that is an operation parameter output by a reference machine device control model, which is a machine learning model established by machine learning an operation on a reference machine device as a reference of the machine device;
converting the at least one reference operation parameter into at least one behavior parameter that does not depend on individual machine device using a machine device model which is a physical model based on a machine characteristic of the reference machine device; and
outputting converted at least one behavior parameter, as a reference conversion unit; and
the at least one processor with the memory is configured to cause the data device to execute:
reconverting the at least one behavior parameter, output in the outputting of the converted at least one behavior parameter, into at least one control operation parameter that is an operation parameter having a same type of the at least one reference operation parameter, according to a machine characteristic of a control target machine device, which is a control target of the machine device, as a reconversion unit.

19. The control system according to claim 17, wherein:
the at least one control operation parameter reconverted in the reconverting of the at least one behavior parameter is output to the control target machine device to autonomously drive the control target machine device.

20. The control system according to claim 19, wherein:
the at least one control operation parameter reconverted in the reconverting of the at least one behavior parameter includes an acceleration and deceleration amount and a front wheel steering angle; and
the control target machine device is controlled to execute autonomous driving based on the acceleration and deceleration amount and the front wheel steering angle using an accelerator, a brake device and a steering device of the control target machine vehicle.
